(19) United States
(12) Patent Application Publication
(10) Pub. No.: US 2011/0232346 A1
(43) Pub. Date: Sep. 29, 2011

(54) SYSTEM AND METHOD FOR PRODUCING SOLID FUEL

(76) Inventor: Paul R. Felger, Ft. Wayne, IN (US)

(21) Appl. No.: 13/155,254

(22) Filed: Jun. 7, 2011

Related U.S. Application Data
(63) Continuation of application No. 11/562,643, filed on Nov. 22, 2006.
(60) Provisional application No. 60/739,647, filed on Nov. 23, 2005.
(60) Provisional application No. 60/746,542, filed on May 5, 2006.

(51) Int. Cl. C05F 11/00; C10L 5/44

(52) U.S. Cl. 71/23; 44/605

(57) ABSTRACT

A system and method for producing solid fuel may comprise a base material in the form of at least one of biomaterial waste and one or more agricultural crops. The base material is combined with at least one additive, wherein the combination of the base material and the at least one additive has at least one property that is different than that of the base material. The combination of the base material and the at least one additive is processed to form the solid fuel.

### CROSS-REFERENCE TO RELATED APPLICATIONS

This application claims the benefit of, and priority to, U.S. Provisional Patent Application Ser. No. 60/739,647, filed Nov. 23, 2005, and U.S. Provisional Patent Application Ser. No. 60/746,542, filed May 5, 2006, the disclosures of which are incorporated herein by reference.

### FIELD OF THE INVENTION

The present invention relates generally to systems for producing solid fuel, and more specifically to systems for producing solid fuel from one or a combination of biomaterial waste and agricultural crops.

### BACKGROUND

Large quantities of biomaterial waste are produced daily by families in urban and rural areas, by industrial facilities, such as from food processing plants, slaughterhouses, and other industrial sources of organic waste, and by agricultural sources, such as livestock and poultry feeding operations. Conventional methods of waste disposal include land application of animal waste, disposal in sanitary landfills, and disposal by processing in composting plants. However, the large volume of waste being generated cannot be adequately handled by using the presently available methods for waste disposal. It is accordingly desirable to process biomaterial waste from a variety of sources into useful products such as a solid, burnable fuel.

Agricultural plants are known to have various physical characteristics and properties. It is also desirable to select a number of such plants each having one or more particular physical characteristics to process into useful products such as a solid, burnable fuel.

### SUMMARY

The present invention may comprise one or more of the features recited in the attached claims, and/or one or more of the following features and combinations thereof. In one embodiment, a system for processing biomaterial waste may comprise a first mixer and a dryer. In this embodiment, the first mixer may be configured to mix the biomaterial waste with at least one biomaterial additive to form a biomaterial combination having a BTU value that is within a first range of BTU values. The dryer may be configured to dry the biomaterial combination to produce a dried biomaterial product, wherein the dried biomaterial product may be burnable to produce heat having a BTU value that is within the first range of BTU values.

The system may further comprise a hammer mill configured to reduce the dried biomaterial product to a powder product. The system may further comprise a burner configured to burn the powder product to produce heat having a BTU value that is within the first range of BTU values.

The system may further comprise a second mixer configured to mix the dried biomaterial product with at least one dry additive to form a dried biomaterial product combination having a BTU value that is within a second range of BTU values greater than the first range of BTU values. Alternatively or additionally, the second mixer may be configured to mix the dried biomaterial product with at least one dry additive to form a dried biomaterial product combination that has at least one physical property that is different than that of the dried product. For example, the at least one dry additive may illustratively include an additive that causes the dried biomaterial product combination to produce less dust than that of the dried biomaterial product. In this example, the at least one dry additive may illustratively include wax or other suitable binder.

The biomaterial waste may include any one or more of animal waste, one or more byproducts of a food processing operation, at least a portion of one or more animals, one or more plants, one or more byproducts of a sawmill, one or more paper products, and oil. As one illustrative example, the biomaterial waste may be or include animal manure.

In another embodiment, a system for processing biomaterial waste may comprise a dryer and a mixer. In this embodiment, the dryer may be configured to dry the biomaterial waste to produce a dried biomaterial product. The mixer may be configured to mix the dried biomaterial product with at least one dry biomaterial additive to form a dried biomaterial product combination having a BTU value that is within a range of BTU values. The dried biomaterial product combination may be burnable to produce heat having a BTU value that is within the range of BTU values.

The system may further comprise a hammer mill configured to reduce the dried biomaterial product combination to a powder product. The system may further comprise a burner configured to burn the powder product to produce heat having a BTU value that is within the range of BTU values.

The biomaterial waste may include any one or more of animal waste, one or more byproducts of a food processing operation, at least a portion of one or more animals, one or more plants, one or more byproducts of a sawmill, and one or more paper products. As one illustrative example, the biomaterial waste may be or include animal manure.

In a further embodiment, a system for processing biomaterial waste may comprise a dryer and a mixer. In this embodiment, the dryer may be configured to dry the biomaterial waste to produce a dried biomaterial product. The mixer may be configured to mix the dried biomaterial product with at least one dry additive to form a dried biomaterial product combination that has at least one physical property that is different than that of the dried biomaterial product. For example, the at least one dry additive may illustratively be or include an additive that causes the dried biomaterial product combination to produce less dust than that of the dried biomaterial product. In this example, the at least one dry additive may illustratively be or include paraffin wax.

In yet another embodiment, a system for processing biomaterial waste may comprise a first mixer and a dryer. In this embodiment, the first mixer may be configured to mix the biomaterial waste with at least one biomaterial additive to form a biomaterial combination having a BTU value that is within a first range of BTU values and that has a nutrient content. The dryer may be configured to dry the biomaterial combination to produce a dried biomaterial product. The dried biomaterial product may be burnable to produce heat having a BTU value that is within the first range of BTU values and to produce an ash containing the nutrient content.

The system may further comprise a hammer mill configured to reduce the dried biomaterial product to a powder product. The system may further comprise a burner configured to burn the powder product to produce heat having a BTU value that is within the first range of BTU values and to produce the ash containing the nutrient content.

The system may further comprise a second mixer configured to mix the dried biomaterial product with at least one dry additive to form a dried biomaterial product combination having a BTU value that is within a second range of BTU values greater than the first range of BTU values. Alternatively or additionally, the second mixer may be configured to mix the dried biomaterial product with at least one dry additive to form a dried biomaterial product combination that has at least one physical property that is different than that of the dried biomaterial product. For example, the at least one dry additive may be or include an additive that causes the dried biomaterial product combination to produce less dust than that of the dried biomaterial product. In this example, the at least one dry additive may illustratively be or include paraffin wax.

The biomaterial waste may include any one or more of animal waste, one or more byproducts of a food processing operation, at least a portion of one or more animals, one or more plants, one or more byproducts of a sawmill, and one or more paper products. As one illustrative example, the biomaterial waste may be or include animal manure.

In a further embodiment, a system is provided for processing biomaterial waste having a BTU value that is within a first range of BTU values and having a nutrient content. In this embodiment, the system may comprise a dryer and a mixer. The dryer may be configured to dry the biomaterial waste to produce a dried biomaterial product. The mixer may be configured to mix the dried biomaterial product with at least one dry biomaterial additive to form a dried biomaterial product combination having a BTU value that is within a second range of BTU values greater than the first range of BTU values. The dried biomaterial product combination may be burnable to produce heat having a BTU value that is within the second range of BTU values and to produce an ash containing the nutrient content of the biomaterial waste.

The system may further comprise a hammer mill configured to reduce the dried biomaterial product combination to a powder product. The system may further comprise a burner configured to burn the powder product to produce heat having a BTU value that is within the second range of BTU values.

The biomaterial waste may include any one or more of animal waste, one or more byproducts of a food processing operation, at least a portion of one or more animals, one or more plants, one or more byproducts of a sawmill, and one or more paper products. As one illustrative example, the biomaterial waste may be or include animal manure.

A method of processing biomaterial waste may comprise evaluating the biomaterial waste to determine a BTU value thereof, determining at least one biomaterial additive having a BTU value that is higher than the BTU value of the biomaterial waste, determining relative proportions of the biomaterial waste and the at least one biomaterial additive which, when combined, have a BTU value that is within a first range of BTU values and that is higher than the BTU value of the biomaterial waste, and combining the biomaterial waste and the at least one biomaterial additive according to the relative proportions to form a biomaterial combination.

The method may further comprise drying the biomaterial combination to produce a dried biomaterial product. The method may further comprise reducing the dried biomaterial product to a powder product. The method may further comprise burning the powder product to produce heat that is within the first range of BTU values.

In one embodiment, the method may further comprise evaluating the dried biomaterial product to determine a BTU value thereof, determining at least one dry additive having a BTU value that is higher than the BTU value of the dried biomaterial product, determining relative proportions of the dried biomaterial product and the at least one dry additive which, when combined, have a BTU value that is within a second range of BTU values and that is higher than the BTU value of the dried biomaterial product, and combining the dried biomaterial product and the at least one dry additive according to the relative proportions to form a dried biomaterial product combination. In this embodiment, the method may further comprise reducing the dried biomaterial product combination to a powder product. The method may further comprise burning the powder product to produce heat having a BTU value that is within the second range of BTU values.

In another embodiment, the method may further comprise determining at least one dry additive to combine with the dried biomaterial product to increase safety of the dried biomaterial product, determining relative proportions of the dried biomaterial product and the at least one dry additive which, when combined, results in a combination thereof that achieves at least one product safety goal, and combining the dried biomaterial product and the at least one dry additive according to the relative proportions to form a dried biomaterial product combination. In this embodiment, the method may further comprise reducing the dried biomaterial product combination to a powder product. The method may further comprise burning the powder product to produce heat having a BTU value that is within the first range of BTU values.

Another method of processing biomaterial waste may comprise evaluating the biomaterial waste to determine a BTU value thereof, drying the biomaterial waste to form a dried biomaterial product, determining at least one dry additive having a BTU value that is higher than the BTU value of the dried biomaterial product, determining relative proportions of the dried biomaterial product and the at least one dry additive which, when combined, have a BTU value that is within a range of BTU values and that is higher than the BTU value of the dried biomaterial product, and combining the dried biomaterial product and the at least one dry additive according to the relative proportions to form a dried biomaterial product combination. The method may further comprise reducing the dried biomaterial product combination to a powder product. The method may further comprise burning the powder product to produce heat having a BTU value that is within the range of BTU values.

Yet another method of processing biomaterial waste may comprise evaluating the biomaterial waste to determine a BTU value and a nutrient content thereof, determining at least one biomaterial additive having a BTU value that is higher than the BTU value of the biomaterial waste, determining a first range of BTU values as a function of the nutrient content of the biomaterial waste and that is higher than the BTU value of the biomaterial waste, determining relative proportions of the biomaterial waste and the at least one biomaterial additive which, when combined, have a BTU value that is within the first range of BTU values, combining the biomaterial waste and the at least one biomaterial additive according to the relative proportions to form a biomaterial combination, and burning the biomaterial combination to produce heat having a BTU value that is within the first range of BTU values and to produce ash, the ash having value as a fertilizer. The method may further comprise drying the biomaterial combination to produce a dried biomaterial product. In this case, burning the biomaterial combination may comprise burning the dried biomaterial product. The method may further comprising reducing the dried biomaterial product to a powder product. In this case, burning the dried biomaterial product may comprise burning the powder product.

In one embodiment, the method may further comprise evaluating the dried biomaterial product to determine a BTU value thereof, determining a second range of BTU values as a function of the nutrient content of the dried biomaterial product and that is higher than the BTU value of the dried biomaterial product, determining at least one dry additive having a BTU value that is higher than the BTU value of the dried biomaterial product, determining relative proportions of the dried biomaterial product and the at least one dry additive which, when combined, have a BTU value that is within the second range of BTU values, and combining the dried biomaterial product and the at least one dry additive according to the relative proportions to form a dried biomaterial product combination. In this case, burning the dried biomaterial product may comprise burning the dried biomaterial product combination to produce heat having a BTU value that is within the second range of BTU values. The method may further comprise reducing the dried biomaterial product combination to a powder product. In this case, burning the dried biomaterial product combination may comprise burning the powder product.

In another embodiment, the method may further comprise determining at least one dry additive to combine with the dried biomaterial product to increase safety of the dried biomaterial product, determining relative proportions of the dried biomaterial product and the at least one dry additive which, when combined, results in a combination thereof that achieves at least one product safety goal, and combining the dried biomaterial product and the at least one dry additive according to the relative proportions to form a dried biomaterial product combination. In this case, burning the dried biomaterial product may comprise burning the dried biomaterial product combination. The method may further comprise reducing the dried biomaterial product combination to a powder product. In this case, burning the dried biomaterial product combination may comprise burning the powder product.

Still a further method of processing biomaterial waste may comprise evaluating the biomaterial waste to determine a BTU value and a nutrient content thereof, drying the biomaterial waste to form a dried biomaterial product, determining a range of BTU values as a function of the nutrient content of the dried biomaterial product and that is higher than the BTU value of the dried biomaterial product, determining at least one dry additive having a BTU value that is higher than the BTU value of the dried biomaterial product, determining relative proportions of the dried biomaterial product and the at least one dry additive which, when combined, have a BTU value that is within the range of BTU values, combining the dried biomaterial product and the at least one dry additive according to the relative proportions to form a dried biomaterial product combination, and burning the dried biomaterial product combination to produce heat having a BTU value that is within the range of BTU values and to produce ash containing the nutrient content of the biomaterial waste, the ash having value as a fertilizer. The method may further comprise reducing the dried biomaterial product combination to a powder product. In this case, burning the dried biomaterial product combination may comprise burning the powder product.

In any of the foregoing methods, the biomaterial waste may include any one or more of animal waste, one or more byproducts of a food processing operation, at least a portion of one or more animals, one or more plants, one or more byproducts of a sawmill, and one or more paper products. As one illustrative example, the biomaterial waste may be or include animal manure.

A system for producing a solid fuel from an agricultural crop combination having a BTU value that is within a first range of BTU values may comprise a grinder configured to grind the agricultural crop combination into a ground agricultural crop combination, and a dryer configured to dry the ground agricultural crop combination to produce a dried, ground agricultural crop combination. The dried, ground agricultural crop combination may be burnable to produce heat having a BTU value that is within the first range of BTU values.

The system may further comprise a mixer configured to mix the dried, ground agricultural crop combination to produce a dry solid fuel. The dry solid fuel may be burnable to produce heat having a BTU value that is within the first range of BTU values.

The system may further comprise a hammer mill configured to reduce the dry solid fuel to a powdered fuel. The system may further comprise a burner configured to burn the powdered fuel to produce heat having a BTU value that is within the first range of BTU values.

Alternatively or additionally, the system may further comprise a pellet making apparatus configured to produce fuel pellets from the dry solid fuel. The system may further comprise a burner configured to burn the fuel pellets to produce heat having a BTU value that is within the first range of BTU values.

The system may further comprise a mixer configured to mix the agricultural crop combination with at least one additive to form a product having at least one physical characteristic that is different than that of the agricultural crop combination. The at least one physical characteristic of the product may include a BTU value that is within a second range of BTU values that is higher than the first range of BTU values. Alternatively or additionally, the at least one physical characteristic of the product may include a nutrient content that is higher than that of the agricultural crop combination. Alternatively or additionally, the at least one physical characteristic of the product may include a product binding property that causes the dried, ground agricultural crop combination to produce less dust than without the at least one additive product.

The system may further comprise a mixer configured to mix the dried, ground agricultural crop combination with at least one additive to form a product having at least one physical characteristic that is different than that of the dried, ground agricultural crop combination. The at least one physical characteristic of the product may include a BTU value that is within a second range of BTU values that is higher than the first range of BTU values. Alternatively or additionally, the at least one physical characteristic of the product may include a nutrient content that is higher than that of the dried, ground agricultural crop combination. Alternatively or additionally, the at least one physical characteristic of the product may include a product binding property that causes the dried, ground agricultural crop combination to produce less dust than without the at least one additive product.

A system for producing a dry solid fuel from a combination of a number of agricultural plants, wherein the combination has at least one physical characteristic, may comprise a grinder configured to grind the combination of the number of agricultural plants into a ground crop combination, a dryer configured to dry the ground crop combination to produce a dried, ground crop combination, and a mixer configured to mix the dried, ground crop combination to produce the dry solid fuel.

The at least one physical characteristic of the combination of a number of agricultural plants may include a BTU value that is within a range of BTU values. Alternatively or additionally, the at least one physical characteristic of the combination of a number of agricultural plants may include a nutrient value that is within a range of nutrient values. Alternatively or additionally, the at least one physical characteristic of the combination of a number of agricultural plants may include a product binding property that causes the dry solid fuel to produce less dust than without the binding property. Alternatively or additionally, the at least one physical characteristic of the combination of a number of agricultural plants may include low silicate content.

The number of agricultural plants may include one or more plants that act as a binder for the dry solid fuel. Alternatively or additionally, the number of agricultural plants may be grown together on a common plot of land and include one or more plants that naturally ward off any one or more of weeds, insects and rodents.

The system may further comprise a hammer mill configured to reduce the dry solid fuel to a powdered fuel. The system may further comprise a burner configured to burn the powdered fuel to produce heat having a BTU value that is within a range of BTU values.

Alternatively or additionally, the system may further comprise a pellet making apparatus configured to produce fuel pellets from the dry solid fuel. The system may further comprise a burner configured to burn the fuel pellets to produce heat having a BTU value that is within a range of BTU values.

A method of producing a dry solid fuel may comprise growing a combination of a number of agricultural plants together on a common plot of land, grinding the combination of a number of agricultural plants into a ground crop combination, drying the ground crop combination, and mixing the ground crop combination to produce the dry solid fuel.

Growing the combination of a number of agricultural plants may comprise including in the combination one or more plants that cause the combination of a number of agricultural plants to have a BTU value that is within a range of BTU values. Alternatively or additionally, growing the combination of a number of agricultural plants may comprise including in the combination one or more plants that cause the combination of a number of agricultural plants to have a nutrient value that is within a range of nutrient values. Alternatively or additionally, growing the combination of a number of agricultural plants may comprise including in the combination one or more plants that provide fibrous bulk for burning and for producing nutritional ash. Alternatively or additionally, growing the combination of a number of agricultural plants may comprise including in the combination one or more plants that naturally ward off any one or more of weeds, insect pests and animal pests. Alternatively or additionally, growing the combination of a number of agricultural plants may comprise including in the combination one or more plants that act as a binder for the dry solid fuel when ground or milled. Alternatively or additionally, growing the combination of a number of agricultural plants may comprise including in the combination one or more plants that provide natural fertilizer for remaining ones of the number of agricultural plants being grown on the common plot of land.

The method may further comprise selecting the number of agricultural plants based on terrain, climate and soil content of the common plot of land. Alternatively or additionally, the method may further comprise selecting the number of agricultural plants to have low or negligible silicate value.

The method may further comprise burning the dry solid fuel to produce heat having a BTU value that is within a range of BTU values. Alternatively or additionally, the method may further comprise using ash resulting from burning the dry solid fuel as fertilizer.

A method of growing an agricultural crop combination on a common plot of land for subsequent burning as a fuel may comprise including in the agricultural crop combination one or more plants that provide fibrous bulk for burning and for producing nutritional ash resulting from burning, and including in the agricultural crop combination one or more plants that cause the agricultural crop combination to have a BTU value that is within a range of BTU values.

The method may further comprise including in the agricultural crop combination one or more plants that naturally ward off any one or more of weeds, inspect pests and animal pests. Alternatively or additionally, the method may further comprise including in the agricultural crop combination one or more plants that act as a binder for the dry solid fuel when the dry solid fuel is ground or milled. Alternatively or additionally, the method may further comprise including in the agricultural crop combination one or more plants that provide natural fertilizer for the remaining agricultural crop combination.

The method may further comprise selecting the one or more plants that provide fibrous bulk and the one or more plants that cause the agricultural crop to have the BTU value based on terrain, climate and soil content of the common plot of land. Alternatively or additionally, the method may further comprise selecting the one or more plants that provide fibrous bulk and the one or more plants that cause the agricultural crop to have the BTU value to have low or negligible silicate values.

A method of growing an agricultural crop combination on a common plot of land for subsequent burning as fuel may comprise including in the agricultural crop combination one or more plants that provide fibrous bulk for burning and for producing nutritional ash resulting from burning, and including in the agricultural crop combination one or more plants that cause the agricultural crop combination to have a nutrient value that is within a range of nutrient values.

The method may further comprise including in the agricultural crop combination one or more plants that naturally ward off any one or more of weeds, inspect pests and animal pests. Alternatively or additionally, the method may further comprise including in the agricultural crop combination one or more plants that act as a binder for the dry solid fuel when the dry solid fuel is ground or milled. Alternatively or additionally, the method may further comprise including in the agricultural crop combination one or more plants that provide natural fertilizer for the remaining agricultural crop combination.

The method may further comprise selecting the one or more plants that provide fibrous bulk and the one or more plants that cause the agricultural crop to have the BTU value based on terrain, climate and soil content of the common plot of land. Alternatively or additionally, the method may further comprise selecting the one or more plants that provide fibrous bulk and the one or more plants that cause the agricultural crop to have the BTU value to have low or negligible silicate values.

A method of producing a solid fuel may comprise providing a base material in the form of at least one of biomaterial waste and one or more agricultural crops, combining the base material with at least one additive, the combination of the base material and the at least one additive having at least one property that is different than that of the base material, and processing the combination of the base material and the at least one additive to form the solid fuel.

Processing the combination of the base material and the at least one additive may comprise processing the combination of the base material and the at least one additive to form a powdered fuel. Alternatively or additionally, processing the combination of the base material and the at least one additive may comprise processing the combination of the base material and the at least one additive to form fuel pellets. The base material may have an associated BTU value. The at least one additive may have a BTU value that is greater than the associated BTU value such that combining the base material with at least one additive results in the combination having a BTU value that is greater than the associated BTU value. Combining the base material with the at least one additive may comprise selecting the at least one additive to have a BTU value which, when combined with the base material, results in the combination that achieves a target BTU value.

The base material may have an associated nutrient value. The at least one additive may have a nutrient value that is greater than the associated nutrient value such that combining the base material with at least one additive results in the combination having a nutrient value that is greater than the associated nutrient value. Combining the base material with the at least one additive may comprise selecting the at least one additive to have a nutrient value which, when combined with the base material, results in the combination that achieves a target nutrient value.

The solid fuel may be burned to produce ash having the target nutrient value, and the ash may be used as fertilizer.

Solid fuel formed without the at least one additive may produce dust when handled. The at least one additive includes a binder which, when combined with the base material, reduces dust produced by handling of the resulting solid fuel.

Solid fuel formed without the at least one additive may produce emissions having a number of emission elements when burned. The at least one additive may reduce emission of at least one of the number of emission elements resulting from burning of the resulting solid fuel.

The biomaterial waste may comprise animal manure.

A system for producing solid fuel may comprise a mixer configured to combine a base material in the form of at least one of biomaterial waste and one or more agricultural crops with at least one additive, and a mill. The combination of the base material and the at least one additive may have at least one property that is different than that of the base material. The mill may be configured to process the combination of the base material and the at least one additive to produce the solid fuel in powder or pellet form.

The biomaterial waste may comprise animal manure.

The base material may have a first BTU value. The at least one additive may have a second BTU value that is higher than the first BTU value so that the combination of the base material and the at least one additive has a resulting BTU value that is higher than the first BTU value.

The base material may have a first nutrient value. The at least one additive may have a second nutrient value that is higher than the first nutrient value so that the combination of the base material and the at least one additive has a resulting nutrient value that is higher than the first nutrient value.

A first solid fuel produced without the at least one additive may produce dust when handled. The at least one additive may comprise a binder which, when combined with the base material, results in second solid fuel that produces less dust than the first solid fuel when handled.

A first solid fuel produced without the at least one additive may produce emissions having a number of emission elements when burned. The at least one additive may comprise a binder which, when combined with the base material, results in a second solid fuel which, when burned, produces less of at least one of the number of emission elements than the first solid fuel.

The at least one additive may comprise a binder that increases the lubricity of the mill when then mill processes the combination of the base material and the at least one additive.

A method of producing a dry solid fuel may comprise growing a combination of a number of agricultural plants together on a common plot of land, grinding the combination of a number of agricultural plants into a ground crop combination, drying the ground crop combination, and mixing the ground crop combination to produce the dry solid fuel.

Growing the combination of a number of agricultural plants may comprise including in the combination one or more plants that cause the combination of a number of agricultural plants to have a BTU value that is within a range of BTU values.

Growing the combination of a number of agricultural plants may comprise including in the combination one or more plants that cause the combination of a number of agricultural plants to have a nutrient value that is within a range of nutrient values.

Growing the combination of a number of agricultural plants may comprise including in the combination one or more plants that provide fibrous bulk for burning and for producing nutritional ash.

Growing the combination of a number of agricultural plants may comprise including in the combination one or more plants that naturally ward off at least one of weeds, insect pests and animal pests.

Growing the combination of a number of agricultural plants may comprise including in the combination one or more plants that act as a binder for the dry solid fuel when ground or milled.

Growing the combination of a number of agricultural plants may comprise including in the combination one or more plants that provide natural fertilizer for remaining ones of the number of agricultural plants being grown on the common plot of land.

The method may further comprise selecting the number of agricultural plants based on terrain, climate and soil content of the common plot of land.

The method may further comprise burning the dry solid fuel to produce heat having a BTU value that is within a range of BTU values.

The method may further comprise using ash resulting from burning the dry solid fuel as fertilizer.

Growing the combination of a number of agricultural plants may comprise including in the combination one or more plants that control emission of at least one emission element resulting from burning of the dry solid fuel.

### BRIEF DESCRIPTION OF THE DRAWINGS

FIG. 1 is a block diagram of one illustrative embodiment of a system for processing biomaterial waste into a burnable fuel.

FIG. 2 is a flowchart of one illustrative process for establishing a recipe for modifying the content of any particular composition of biomaterial waste prior to drying to achieve a target BTU and/or a target nutrient content.

FIG. 3 is a flowchart of one illustrative process for establishing a recipe for modifying the content of the dried biomaterial product to achieve target BTU, nutrient content and/or safety goals.

FIG. 4 is a flowchart of one illustrative process for growing a number of agricultural plants together on a single plot of land to form a crop combination that achieves one or more target characteristics of a resulting solid fuel.

FIG. 5 is a block diagram of a system for processing the crop combination resulting from the process of FIG. 4 into a burnable solid fuel.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

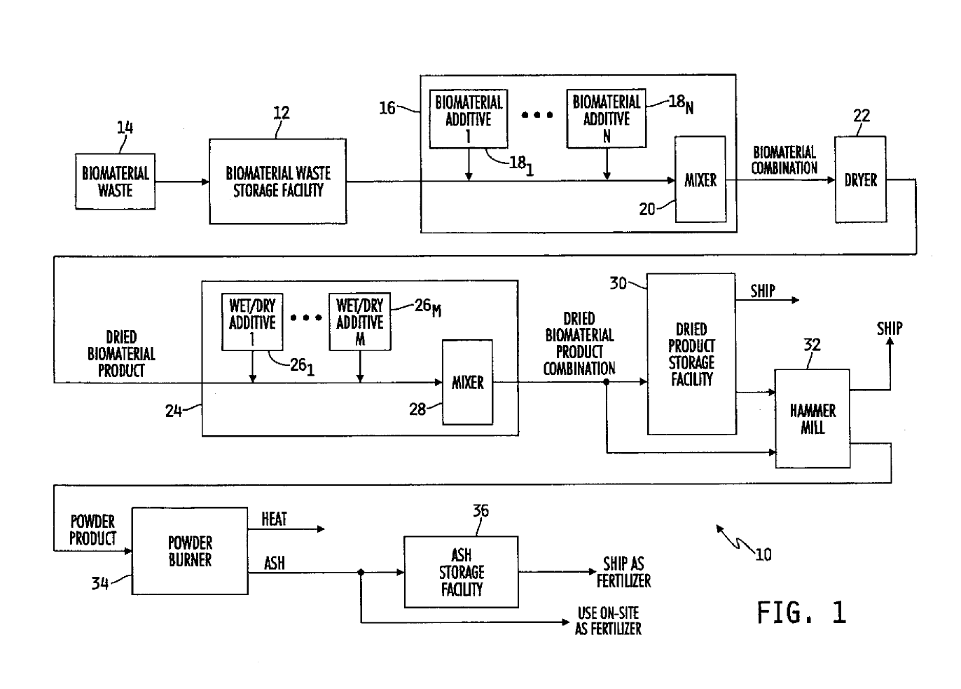

Referring now to FIG. 1, a block diagram of one illustrative embodiment of a system 10 for processing biomaterial waste into a burnable fuel is shown. In the illustrative embodiment, some of the stages of the system 10 are optional, and therefore may or may not be included in particular embodiments of the system 10. Such optional stages will be identified in the following description.

In the illustrated embodiment, the system 10 includes a biomaterial waste storage facility 12 to which biomaterial waste 14 is delivered. The term “biomaterial waste,” as this term is used herein, may be or include, but should not be limited to, animal waste in the form of manure, animal parts and/or whole animals, waste produced by food processing operations including, for example, diary waste, fish, poultry, pork and/or beef waste, fruit and/or vegetable waste, wheat, grain and/or flour product waste, oil waste, agricultural waste, municipal waste, such as in the form of leaves, sticks and other debris, and other industrial or non-industrial sources of organic waste. In any case, the biomaterial waste storage facility 12 may include one or more storage bins or locations for storing the biomaterial waste 14, and any conventional transport mechanism may be used to deliver the biomaterial waste 14 to the biomaterial waste storage facility 12.

The system 10 may optionally include a biomaterial additive and mixing stage 16 that includes any number, N, of biomaterial additive sources 18₁-18_{N}, wherein N may be any positive integer. A conventional conveyor, auger or other conventional transport mechanism may be used to transport the biomaterial waste 14 from the biomaterial waste storage facility 12 to or past the one or more biomaterial additive sources 18₁-18_{N} and then to a biomaterial waste mixer 20. The mixer 20 may be a conventional mixer configured to combine or blend the biomaterial waste 14 with the one or more biomaterial additives 18₁-18_{N}. In one embodiment, for example, the mixer 20 may be a conventional pinwheel mixer produced by Feeco International, Inc. of Green Bay, Wis. The one or more biomaterial additives 18₁-18_{N} may be or include, but should not be limited to, biomaterial waste from any farming, agricultural, municipal or industrial operation including any one or more of the biomaterial waste examples provided hereinabove, and one or more plants or crops having one or more desirable properties. In any case, the biomaterial waste 14, as well as any one or more of the biomaterial additives 18₁-18_{N}, may have some moisture content, and in some cases may have considerable moisture content. The system 10 accordingly includes a dryer 22 to which the biomaterial waste 14 alone, or biomaterial combination of the biomaterial waste 14 and any one or more of the biomaterial additives 18₁-18_{N}, is transported via any conventional transportation mechanism. Generally, the dryer 22 may be a single or multiple-pass dryer that may be of conventional construction. In one embodiment, for example, the dryer 22 is a Belt-O-Matic continuous flow, conveyor type dryer manufactured by BNW Industries of Mentone, Ind. Generally, the operational features of the dryer 22, such as dryer temperature, speed of transport of the biomaterial waste 14 or biomaterial composition through the dryer 22, air-flow rate, and the like, are selected based on the moisture content and/or volume of the biomaterial waste 14 or biomaterial combination, and are selected to achieve a moisture content of the resulting dried biomaterial product that is at or less than a target moisture content. Alternatively, the dryer 22 may be outfitted with a conventional electronic control system configured to sense the moisture content of the biomaterial waste 14 or biomaterial combination, and to control the operational parameters of the dryer 22 accordingly to dry the biomaterial waste 14 or biomaterial composition to achieve a moisture content of the resulting dried biomaterial product that is at or less than the target moisture content. The dried biomaterial product is produced at the outlet of the dryer 22.

The system 10 may include a wet/dry additive stage 24, and in this embodiment the dried biomaterial product is supplied to the wet/dry additive stage via a conventional transport mechanism. The wet/dry additive stage 24 includes any number, M, of wet and/or dry additive sources 26₁-26_{M}, wherein M may be any positive integer. A conventional conveyor or other conventional transport mechanism transports the dry biomaterial product to or past the one or more wet and/or dry additive sources 26₁-26_{M}, and then to another mixer 28. Emerging from the wet/dry additive stage 24 is a dried biomaterial product combination of the dried biomaterial product supplied by the dryer 22 and one or more of the wet and/or dry additives 26₁-26_{M}. The mixer 28 may be a conventional mixer like the mixer 22 described hereinabove, or may be another conventional mixer configured to combine, mix or blend wet and/or dry products.

The one or more wet and/or dry additives 26₁-26_{M} may be or include, but should not be limited to, dried organic waste from any farming, agricultural or industrial operation including any one or more of the biomaterial waste examples provided hereinabove, one or more plants or crops, any conventional wet and/or dry binding, sticky and/or clumping additives, such as wax, syrup, ice cream or other blinding, sticky or otherwise clumping additives.

The dried biomaterial product combination emerging from the mixer 28, or the dried biomaterial product combination emerging from the dryer 22, may be supplied to an optional dried product storage facility 30, or may instead be supplied directly to a conventional hammer mill 32. The optional dried product storage facility 30 may be used to store the dried biomaterial product or dried biomaterial product combination for subsequent shipment to another location or for subsequent supply to the hammer mill 32 as illustrated in FIG. 1.

The hammer mill 32 is of conventional construction, and is configured to reduce the dried biomaterial product or dried biomaterial product combination to a powder product that may be shipped for use or storage at another location, or that may instead be supplied to a conventional on-site powder burner 34. Illustratively, the hammer mill 32 may be a conventional hammer mill manufactured by Prater-Sterling Industries of Bollingbrook, Ill., or may alternatively be another conventional hammer mill, grinder or other conventional machine that reduces dry product to a power product. For purposes of this document, “powder” is defined as having components or particles ranging in size or degree from a fine dust, e.g., similar to conventional mill flour or powdered coal, to granules having diameters of up to, for example, approximately 3/16 inches. Optionally, the hammer mill 32 may be preceded by a conventional clarifier, e.g., 15-mesh, that is configured to remove components of the dried biomaterial product or dried biomaterial combination that may be difficult to reduce to power form, e.g., straw, etc.

The powder burner 34 may be a conventional powder burner, such as a Thermix combustion system that is manufactured in Germany and is currently distributed in the United States through Tarmac International, Inc. of Blue Springs, Mo., or other conventional powder burner. In any case, the powder burner 34 is configured to burn the powdered product and produce heat (described herein in British thermal units or BTU) and ash or residue. Depending upon the composition of the powder product, the ash may have some, perhaps even considerable, nutrient content which has value as fertilizer. The system 10 may therefore optionally have an ash storage facility 36 that is sized and configured to store the ash produced by the powder burner 34 for later use on-site, or for shipment to another location for use, as fertilizer. Alternatively, the ash may be used directly and immediately on-site as a fertilizer product.

In alternative embodiments, the hammer mill 32 and powder burner 34 may be replaced by a conventional pellet mill and corresponding conventional pellet burner. In this embodiment, the pellet mill may be, for example, a pellet mill that is commercially available from California Pellet Mill of Crawfordsville, Ind., a pellet mill that is commercially available from Bliss Industries of Ponca City, Okla., or the like.

The present disclosure contemplates various configurations of the system 10 with regard to the components illustrated in FIG. 1. In one embodiment, for example, the system 10 may omit the biomaterial additive stage 16, in which case the biomaterial waste 14 is supplied from the biomaterial waste storage facility 12, or from the source of the biomaterial waste 14, via a conventional transport mechanism directly to the dryer 22. In another embodiment, the system 10 may omit the wet/dry additive stage 24, in which case the dried biomaterial product exiting the dryer 22 is supplied via a conventional transport mechanism directly to the dry product storage facility 30 or to the hammer mill 32. In yet another embodiment, the system 10 may omit the direct path of the dried biomaterial product or dried biomaterial product combination to the hammer mill 32. In this embodiment, the dried biomaterial product or dried biomaterial product combination is necessarily stored in the dry product storage facility 30 for subsequent shipment to another location and/or for subsequent processing by the hammer mill 32. In still another embodiment, the system 10 may omit the dry product storage facility 30, in which case the dried biomaterial product or dried biomaterial product combination is transported directly to the hammer mill 32. In this embodiment, the powder product produced by the hammer mill 32 may be shipped to a different location for storage or use, and/or be provided directly to an on-site powder burner 34. Those skilled in the art will recognize that it may be desirable to include the dry product storage facility 30 in embodiments of the system 10 wherein the dried biomaterial product or dried biomaterial product combination will not be immediately burned. This is because the powder product is typically more volatile and flammable than the dried biomaterial product or the dried biomaterial product combination, and it may therefore it be safer to store the dried biomaterial product or dried biomaterial product combination in its pre-powder form rather than in its powder product form. Finally, in some embodiment of system 10, the ash storage facility 36 may be included, and in others it may be omitted.

Regardless of the configuration of the system 10, in terms of inclusion of one or more of its optional components, the present disclosure contemplates various implementations of the system 10 in terms of the physical location(s) of its various components. In one illustrative embodiment, for example, the entirety of the system 10 resides at a single location so that the biomaterial waste 14 may be processed into the powder product and burned on-site to produce heat for some specified operation or operations, and/or for use of the ash as fertilizer. In another illustrative embodiment, everything except the biomaterial waste 14 may reside together at a single location, in which case the biomaterial waste 14 may be shipped using any conventional transportation mechanism to the biomaterial waste processing system 10. In yet another illustrative embodiment, the system 10 may include stages 12-30 at a single location, and the hammer mill 32 and the powder burner 34 may reside at a different or remote location. Those skilled in the art will recognize that it may be desirable, in this embodiment, to pass the dried biomaterial product or the dried biomaterial product combination through the hammer mill 32 just prior to burning in the powder burner 34 for safety reasons (e.g., relating to combustibility), although the hammer mill 32 may alternatively be co-located with the stages 12-24 or 12-30.

It is generally understood that any form of biomaterial waste 14 has an associated BTU value or range of BTU values depending on its composition. In some cases, the biomaterial waste 14 by itself defines a BTU value or range of values that is convenient or sufficient to burn in powder (or pellet) form using the powder (or pellet) burner 34. In other cases, the BTU value or range of values defined by the biomaterial waste 14 is lower than desired to burn in powder (or pellet) form using the powder (or pellet) burner 34. In such cases, the biomaterial additive stage 16 may be included in the system 10, and one or more biomaterial additives 18₁-18_{N} may be added to increase the BTU value or range of values of the biomaterial waste 14. In this embodiment, the one or more biomaterial additives 18₁-18_{N}, either separately or together, define a BTU value or range of values that is higher than the BTU value or range of values of the biomaterial waste 14 so that when the one or more biomaterial additives 18₁-18_{N} are combined with the biomaterial waste 14 in the mixer 20, the resulting biomaterial combination will have a BTU value or range of values that is above the BTU value or range of BTU values of that of the biomaterial waste 14 alone. The BTU value or range of values sought to be attained with the resulting biomaterial combination may be referred to herein as a target BTU value or target range of BTU values.

It is likewise generally understood that any form of biomaterial waste 14 has an associated nutrient value depending on its composition. The ash or residue left after burning such biomaterial waste 14 may thus have value as a fertilizer. In some cases, the biomaterial waste 14 by itself has a sufficient nutrient value such that ash left over from burning the biomaterial waste 14 alone has a sufficient nutrient value to be useful as fertilizer. In other cases, the nutrient value of the biomaterial waste 14 is lower than desired so that the nutrient value of the ash left over from burning the biomaterial waste 14 is lower than desired for use as fertilizer. In such cases, the biomaterial additive stage 16 may be included in the system 10, and one or more biomaterial additives 18₁-18_{N} may be added to increase the nutrient value of the biomaterial waste 14. In this embodiment, the one or more biomaterial additives 18₁-18_{N}, either separately or together, have a nutrient value that is higher than the nutrient value of the biomaterial waste 14 so that when the one or more biomaterial additives 18₁-18_{N} are combined with the biomaterial waste 14 in the mixer 20, the resulting biomaterial combination will have a nutrient value that is above the nutrient value of that of the biomaterial waste 14 alone. The nutrient value sought to be attained with the resulting biomaterial combination may be referred to herein as a target nutrient value.

In other embodiments, the biomaterial additive stage 16 may be included in the system 10, and the one or more biomaterial additives 18₁-18_{N} may be added to the biomaterial waste 14 to achieve one or more other properties of the resulting dried biomaterial product or dried biomaterial product combination. For example, one or more biomaterial additives 18₁-18_{N} may be added to increase or maintain the BTU value or range of BTU values of the biomaterial waste 14 while increasing or maintaining the nutrient content of the biomaterial waste 14. As another example, one or more biomaterial additives 18₁-18_{N} may be added to increase or maintain the BTU value or range of BTU values, and/or to increase or maintain the nutrient content, of the biomaterial waste 14 while decreasing one or more undesirable elements of burn emissions resulting from burning of the powdered or pellet fuel. Examples of undesirable elements of burn emissions may include, but are not limited to, nitrogen, sulfur, mercury, sodium oxide, potassium oxide, alkalies, and the like. As a further example, one or more biomaterial additives 18₁-18_{N} may be added to increase or maintain the BTU value or range of BTU values of, and/or to increase or maintain the nutrient content of, and/or to decrease one or more undesirable elements of burn emissions from, the biomaterial waste 14 while increasing the lubricity of one or more of the solid fuel processing structures, such as the hammer mill 32 (or pellet mill). Those skilled in the art will recognize that one or more conventional biomaterial additives 18₁-18_{N} may be added to the biomaterial waste 14 to achieve one or more of the above or other desirable properties of the dried biomaterial product or dried biomaterial product composition, and adding any such one or combination of conventional biomaterial additives 18₁-18_{N} to the biomaterial waste 14 to achieve such one or more desirable properties is contemplated by this disclosure.

In the same manner as just described with respect to the biomaterial additive stage 16, the dry additive stage 24 may likewise be used, either alone or in combination with the biomaterial additive stage 16, to achieve one or more desirable properties of the dried biomaterial product exiting the dryer 22. The one or more desirable properties of the dried biomaterial product exiting the dryer 22 may be or include any of the one or more desirable properties described hereinabove with respect to the biomaterial additive stage 16, and/or one or more other desirable properties. For example, one or more dry additives 26₁-26_{M} may be selected to achieve one or more safety goals of the resulting dried biomaterial product combination. As one specific example, it has been found that by adding a binder, such as paraffin wax, to the dried biomaterial product, the resulting dried biomaterial product combination not only has increased BTU value but is also less likely to create dust during manufacturing, handling and storage, and is therefore less volatile and combustible. Generally, binder additives, whether wet or dry, act to reduce dust that may be generated during manufacturing, storage and/or handling, and may have one or more additional desirable properties described hereinabove. In any case, those skilled in the art may recognize other dry additives that may be combined with the dried biomaterial product to achieve one or more other safety-related or other goals, and such other additives and combinations are contemplated by the present disclosure.

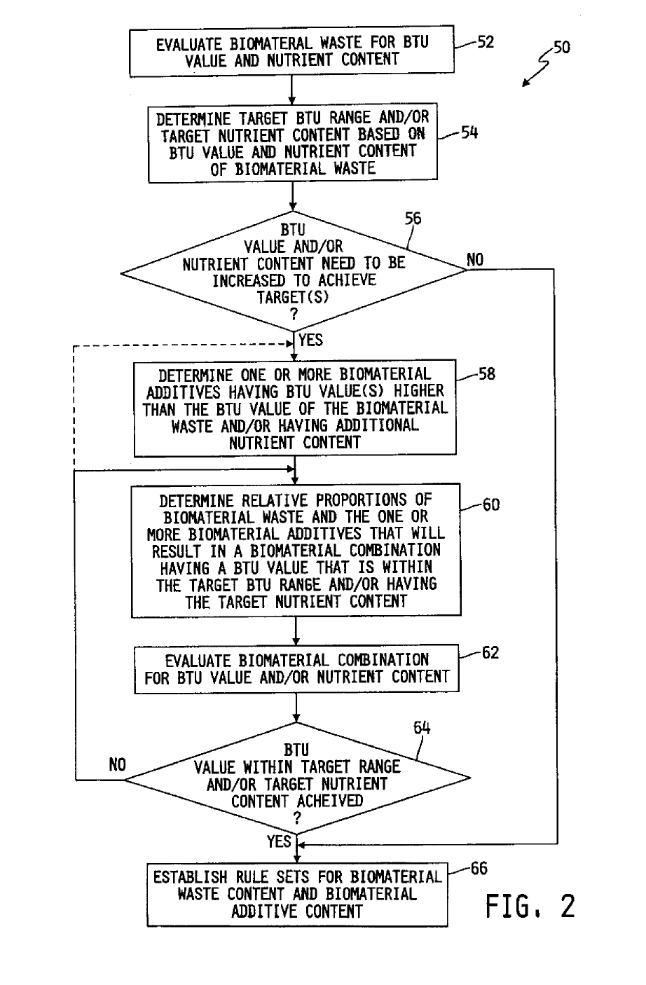

The BTU content and the nutrient content of the biomaterial waste 14 may vary considerably depending upon the composition of the biomaterial waste 14. The composition of the biomaterial waste 14 for any particular implementation of the system 10 will generally be dictated, among other considerations, by geographical location and available sources of biomaterial waste 14 at any such geographical location. In any implementation of the system 10 at any geographical location, the BTU, nutrient content and other pertinent properties of the biomaterial waste 14 must therefore be determined, available sources of one or more biomaterial additives 18₁-18_{N} must be identified and their BTU and/or nutrient content and/or other properties analyzed, and/or the availability of one or more dry additives 26₁-26_{M} must be identified and their BTU and/or nutrient content and/or other properties must also be determined. All such determinations relating to the one or more biomaterial additives 18₁-18_{N} and the one or more dry additives 26₁-26_{M} will typically be driven by the actual BTU and nutrient content of the available biomaterial waste 14, the BTU and/or nutrient content targets for the final powder (or pellet) product that will be burned in the powder (or pellet) burner 34, and/or other considerations such as burn emissions, product safety, processing ease, and the like. In this regard, FIG. 2 is a flowchart of one illustrative process 50 for establishing a recipe and rule sets for modifying the content of any particular composition of biomaterial waste 14 prior to drying in the dryer 22 in order to achieve a target BTU and/or a target nutrient content of the dried biomaterial product emerging from the dryer 22. As described briefly hereinabove, some compositions of the biomaterial waste 14 will require significant modification by one or more biomaterial additives 18₁-18_{N} in order to achieve target BTU and/or target nutrient content goals, while other compositions of the biomaterial waste 14 may require little or no modification to achieve the target BTU and/or target nutrient content goals. It will be understood that the process 50 illustrated in FIG. 2 is provided only as an example process for modifying BTU and/or nutrient content of the biomaterial waste 14, and that the process 50 may be modified to achieve other desirable properties of the biomaterial waste 14 as described hereinabove. Any such modifications to the process 50 to achieve one or more of the properties of the biomaterial waste 14 described hereinabove would comprise mechanical steps for a skilled artisan.

The process 50 illustrated in FIG. 2 begins at step 52 where one evaluates the biomaterial waste 14 for BTU value and nutrient content. Techniques for conducting such an evaluation are generally known and the BTU/nutrient content evaluation process of step 52 may therefore be conducted in a conventional manner. Following step 52, the process 50 advances to step 54 where one determines a target BTU range and/or target nutrient content for the biomaterial composition entering the dryer 22, wherein the target BTU range and/or target nutrient content may be based, at least in part, on the BTU value and nutrient content of the biomaterial waste 14 that was determined at step 52. For example, as described hereinabove, the BTU value and nutrient content of the biomaterial waste 14 will depend on its type and composition, and the target BTU range and/or target nutrient content may therefore depend on the initial BTU value and/or nutrient content of the biomaterial waste 14. Alternatively, the target BTU range and/or target nutrient content may not depend at all on the BTU value and/or nutrient content of the biomaterial waste 14, and may instead be based on one or more other factors, including, for example, but not limited to, a target heat output of the powder (or pellet) burner 34 and/or a target nutrient content of the ash produced by the powder (or pellet) burner 34. In any case, the process 50 advances from step 54 to step 56.

At step 56, a determination is made as to whether the BTU value and/or nutrient content of the biomaterial waste 14 needs to be increased in order to achieve the target BTU range and/or target nutrient content determined at step 54. If not, this means that the biomaterial waste 14 has, by itself, a BTU value that is at or above the target BTU range and/or has a nutrient content that is at or above the target nutrient content. In this case, the biomaterial additive stage 16 is not needed, and may be omitted, and the process 50 advances to step 66. If, on the other hand, it is determined at step 56 that the BTU value and/or nutrient content of the biomaterial waste 14 must be increased in order to achieve the target BTU range and/or target nutrient content determined at step 54, the process 50 advances to step 58 where one determines one or more biomaterial additives having BTU values that are higher than the BTU value of the biomaterial waste 14 and/or that have additional nutrient content. Identification and selection of the one or more biomaterial additives 18₁-18_{N} will depend largely on the geographical location of the system 10 and/or its proximity to one or more suitable sources of biomaterial additives. Generally, then, step 58 is carried out by determining suitable sources of one or more biomaterial additives that are available in the vicinity of the installation of the system 10 and/or that may be transported to the system 10 from one or more remote locations.

Following step 58, the process 50 advances to step 60 where one determines relative portions of the biomaterial waste and the one or more biomaterial additives that will result in a biomaterial combination having a BTU value that is within the target BTU range and/or having at least the target nutrient content. Step 60 may accordingly require some experimentation, and may include evaluating the one or more biomaterial additives for BTU value and/or nutrient content and/or blending various combinations and/or various quantities of the biomaterial waste 14 and the one or more biomaterial additives. In any case, the process 50 advances from step 60 to step 62 where one evaluates the biomaterial combination for BTU value and/or nutrient content using one or more conventional BTU value and/or nutrient content determination techniques. The process 50 then advances from step 62 to step 64 where it is determined whether the BTU value of the biomaterial combination is within the target BTU range and/or whether the target nutrient content has been achieved by the biomaterial combination. If not, the process 50 loops back, in one embodiment, to step 60 where one re-evaluates and re-determines relative proportions of the biomaterial waste 14 and the one or more biomaterial additives 18₁-18_{N} that will result in a biomaterial combination that achieves the target BTU range and/or target nutrient content. Alternatively, the “no” branch of step 64 may loop back to step 58, as shown by the dashed-line in FIG. 2, where one identifies one or more alternative or additional biomaterial additives. In any case, once the biomaterial combination has a BTU value that is within or above the target BTU range and/or has a nutrient content that is at or above the target nutrient content, step 64 advances to step 66 where one establishes rule sets for the biomaterial waste content or composition and biomaterial additive content or composition. Once the process 50 has been completed, these rule sets will be applied to the incoming biomaterial waste 14 and also to the one or more biomaterial additives 18₁-18_{N} in the operation of the system 10 so that the dried biomaterial product exiting the dryer 22 will consistently have a BTU value that is within or above the target BTU range and/or will have a nutrient content that is at or above the target nutrient content. The process 50 will also necessarily establish a recipe for combining relative proportions of the biomaterial waste 14 and the one or more biomaterial additives 18₁-18_{N}, which will be subsequently followed and applied in the operation of the system 10 so that the biomaterial composition entering the dryer 22 will consistently have at least the target BTU value and/or at least the target nutrient content.

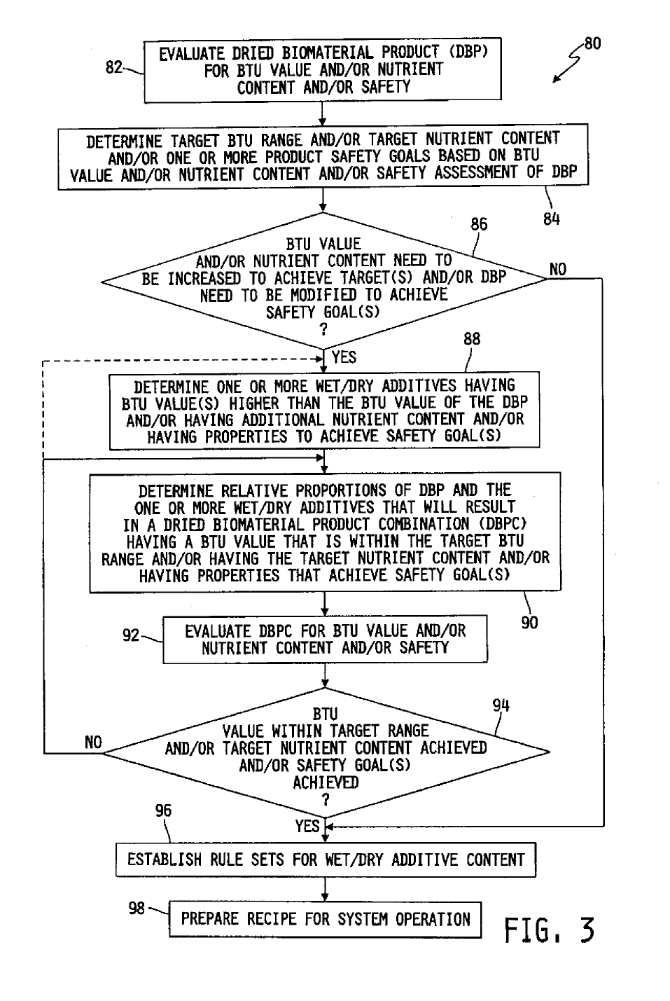

Referring now to FIG. 3, a flow chart of one illustrative process 80 is shown for establishing a recipe for modifying the content of any particular composition of the dried biomaterial product exiting the dryer 22 in order to achieve the initial target BTU and/or target nutrient content described with respect to FIG. 2 or to achieve a second target BTU and/or target nutrient content. It will be recognized that the original target BTU range and/or target nutrient content need not be achieved solely by the biomaterial additive stage 16, but may be instead achieved solely or via a combination of the wet/dry additive stage 24. As with the biomaterial waste 14, some compositions of the dried biomaterial product will require significant modification by one or more dry additives 26₁-26_{M} in order to achieve target BTU and/or target nutrient content goals, while other compositions of the dried biomaterial product may require little or no modification to achieve the BTU and/or target nutrient content goals. It will be understood that the process 80 illustrated in FIG. 3 is provided only as an example process for modifying BTU and/or nutrient content of the biomaterial waste 14, and that the process 80 may be modified to achieve other desirable properties of the biomaterial waste 14 as described hereinabove. Any such modifications to the process 80 to achieve one or more of the properties of the biomaterial waste 14 described hereinabove would comprise mechanical steps for a skilled artisan.

The process 80 illustrated in FIG. 3 begins at step 82 where one evaluates the dried biomaterial product (DBP) for BTU value and/or for nutrient content and/or safety. Techniques for conducting such evaluations are generally known and the BTU/nutrient/safety content evaluation of step 82 is conducted in a conventional manner. Following step 82, the process 80 advances to step 84 where one determines a target BTU range and/or target nutrient content and/or one or more product safety goals based on the BTU value, nutrient content and/or safety assessment of the dried biomaterial product that was determined at step 82. The BTU value, nutrient content and/or safety of the dried biomaterial product will depend largely on its type, composition, and/or one or more physical properties, and the target BTU range and/or target nutrient content may therefore depend on the initial BTU value, target nutrient content and/or one or more target safety goals of the resulting dried biomaterial product combination. Alternatively, the target BTU range, target nutrient content and/or one or more target safety goals may not depend at all on the BTU value, nutrient content and/or safety assessment of the biomaterial waste 14, and may instead be based on one or more other factors, including, for example, but not limited to, a target heat output of the powder (or pellet) burner 34, target nutrient content of the ash produced by the powder (or pellet) burner 34 and/or other product safety concerns. In any case, the process 80 advances from step 84 to step 86.

At step 86, a determination is made as to whether the BTU value and/or nutrient content of the dried biomaterial product needs to be increased in order to achieve the target BTU range and/or target nutrient content determined at step 84, and/or whether the dried biomaterial product needs to be further modified in order to achieve one or more safety goals determined at step 84. If not, this means that the dried biomaterial combination has, by itself, a BTU value that is at or above the target BTU range, a nutrient content that is at or above the target nutrient content, and/or achieves the one or more safety goals. In this case, the wet/dry additive stage 24 is not needed, and may be omitted, and the process 80 advances to step 96. If, on the other hand, it is determined at step 86 that the BTU value and/or nutrient content of the dried biomaterial product must be increased in order to achieve the target BTU range and/or target nutrient content determined at step 84, and/or that the dried biomaterial product needs to be further modified in order to achieve one or more safety goals determined at step 84, the process 80 advances to step 88 where one determines one or more wet or dry additives that have BTU values that are higher than the BTU value of the dried biomaterial product, that have additional nutrient content, and/or that have one or more properties that will cause the resulting dried biomaterial product combination to achieve the one or more safety goals. Identification and selection of the one or more wet or dry additives 26₁-26_{M} may depend on the geographical location of the system 10 and/or its proximity to one or more suitable sources of dry additives, and/or may alternatively or additionally depend on the nature of the one or more safety goals. In any case, step 88 is generally carried out by determining suitable sources of one or more wet or dry additives that are available in the vicinity of the installation of the system 10 and/or that may be transported to the system 10 from one or more remote locations.

Following step 88, the process 50 advances to step 90 where one determines relative portions of the dried biomaterial product and the one or more wet or dry additives that will result in a dried biomaterial product combination having a BTU value that is within the target BTU range determined at step 84, having at least the target nutrient content determined at step 84, and/or having one or more properties that achieve the one or more safety goals determined at step 84. Step 90 may accordingly require some experimentation, and may include evaluating the one or more wet or dry additives for BTU value, nutrient content and/or efficacy in achieving the one or more safety goals, and/or blending various combinations and/or various quantities of the dried biomaterial product and the one or more wet or dry additives. In any case, the process 80 advances from step 90 to step 92 where one evaluates the dried biomaterial product combination for BTU value, nutrient content and/or safety using one or more conventional BTU value, nutrient content and/or safety determination techniques. The process 80 then advances from step 92 to step 94 where it is determined whether the BTU value of the dried biomaterial product combination is within the target BTU range, whether the target nutrient content has been achieved by the dried biomaterial product combination and/or whether the one or more safety goals have been achieved by the dried biomaterial product combination. If not, the process 80 loops back, in one embodiment, to step 90 where one re-evaluates and re-determines relative proportions of the dried biomaterial product and the one or more wet or dry additives 26₁-26_{M} that will result in a dried biomaterial product combination that achieves the target BTU range and\or target nutrient content, and/or that has one or more properties that achieves the one or more safety goals. Alternatively, the “no” branch of step 94 may loop back to step 88, as shown by the dashed-line in FIG. 3, where one identifies one or more alternative or additional wet or dry additives. In any case, once the dried biomaterial product combination has a BTU value that is within or above the target BTU range, has a nutrient content that is at or above the target nutrient content and/or that has one or more properties that achieves the one or more safety goals, step 94 advances to step 96 where one establishes rule sets for the wet or dry additive content or composition. Thereafter at step 98, the recipes resulting from the process 50 and the process 80 are prepared. Once the process 80 has been completed, these rule sets will be applied to the incoming biomaterial waste 14, to the one or more biomaterial additives 18₁-18_{N} in embodiments that include one or more biomaterial additive sources, and to the one or more wet or dry additives 26₁-26_{M} in embodiments that include one or more wet or dry additive sources, in the operation of the system 10 so that the dried biomaterial product combination being supplied to the dried product storage facility 30 and/or hammer mill 32 will consistently have a BTU value that is within or above the target BTU range, will have a nutrient content that is at or above the target nutrient content and/or will have one or more properties that achieve the one or more safety goals. The recipes established for combining relative proportions of the biomaterial waste 14 and the one or more biomaterial additives 18₁-18_{N} and/or for combining relative proportions of the dried biomaterial product and the one or more wet or dry additives 26₁-26_{M} will be subsequently followed and applied in the operation of the system 10 so that the dried biomaterial product combination, and thus the powder (or pellet) product, will consistently have at least the target BTU value and/or at least the target nutrient content, and will also consistently have one or more properties that achieve the one or more safety goals.

### EXAMPLE

An example dried biomaterial waste combination was prepared using the techniques described herein. The base biomaterial waste 14 was duck manure, and a combination of paraffin wax and pine bedding was added at the wet/dry additive stage 24. No biomaterial additive stage 16 was used. A sample of the dried biomaterial waste combination was subjected to a conventional burn test using conventional ASTM Volume 05.06 standards for gaseous fuels, coal and coke methodologies, and the results of this test are set forth in the following tables:

PROXIMATE ANALYSIS

| | % As Received | Dry Basis |
|---|---|---|
| Moisture | 4.52 | |
| Ash | 6.71 | 7.03 |
| Volatile | 74.48 | 78.01 |
| Fixed Carbon | 14.29 | 14.96 |
| Sulfur | 0.25 | 0.26 |
| Btu/lb | 9516 | 9967 |
| MAF Btu/lb | | 10721 |

ULTIMATE ANALYSIS

| | % As Received | Dry Basis |
|---|---|---|
| Carbon | 52.71 | 55.21 |
| Hydrogen | 7.14 | 7.48 |
| Nitrogen | 0.76 | 0.80 |
| Ash | 6.71 | 7.03 |
| Sulfur | 0.25 | 0.26 |
| Oxygen | 27.91 | 29.22 |
| Moisture | 4.52 | |
| Chlorine | 0.09 | 0.09 |
| Fluorine | 0.002 | 0.002 |

ASH FUSION TEMPERATURES (deg F.)

| | Reducing | Oxidizing |
|---|---|---|
| Initial | 2300 | 2600 |
| Softening | 2400 | 2650 |
| Hemispherical | 2490 | 2670 |
| Final | 2540 | 2695 |

FORMS OF SULFUR

| | % Dry Basis |
|---|---|
| Total | 0.26 |
| Pyritic | XXXX |
| Sulfate | XXXX |
| Organic | XXXX |

WATER SOLUBLE ALKALIES

| | % Dry Basis |
|---|---|
| Sodium Oxide | XXXX |
| Potassium Oxide | XXXX |

MINERAL ANALYSIS OF ASH

| | % Ignited Basis |
|---|---|
| Silicon Dioxide | 14.00 |
| Aluminum Oxide | 3.98 |
| Titanium Dioxide | 0.02 |
| Calcium Oxide | 24.60 |
| Potassium Oxide | 8.40 |
| Magnesium Oxide | 5.60 |
| Sodium Oxide | 2.56 |
| Phosphorus Pentoxide | 18.45 |
| Ferric Oxide | 4.46 |
| Sulfur Trioxide | 11.25 |
| Barium Oxide | 0.01 |
| Manganese Dioxide | 0.56 |
| Strontium Oxide | 0.03 |
| Undetermined | 6.08 |
| Base/Acid Ratio: | 2.53 |
| Slag Viscosity T250: | 2450 |
| Fouling Index: | 2.56 |
| *Fouling Type;: | LOW |
| Slagging Index: | 2374 |
| *Slagging Type: | MEDIUM |
| Silica Value | 28.77 |
| % Alkali as Na20: | 0.57 |

*Values estimated

From the Proximate Analysis table, it is evident that the BTU value of the duck manure alone was increased by the addition of pine bedding and paraffin wax from 9516 BTU to 9967 BTU. The amount of ash (7.03%) resulting from addition of the pine bedding was maintained below a target of 8%. From the Mineral Analysis of Ash table, it is apparent that the ash of the combined fuel is devoid of mercury, and contains desirable amounts of Calcium Oxide (24.6%), Potassium Oxide (8.4%) and Phosphorus Pentoxide (18.45%).

Problematic emissions resulting from the burn of the example fuel blend are within target ranges. For example, from the Ultimate Analysis table, Nitrogen composition of the dry blend is 0.8%, which is within a target of less than 1.5%, and Sulfur composition is 0.26%, which is within a target of less than 1%. From the Mineral Analysis of Ash table, the Potassium Oxide and Sodium Oxide contents are 8.4% and 2.56% respectively. Because the ash produced by burning the dry blend is only 7.03%, the combined amounts of the Potassium Oxide and Sodium Oxide is ((8.4%+2.56%)*7.03%)=0.77%, which is acceptable.

Although not illustrated specifically in the above tables, the addition of paraffin wax reduced dust generation from the dried biomaterial waste combination to acceptable levels.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, while the system 10 has been illustrated and described as providing for additive products before and after the dryer 22, the system 10 may alternatively or additionally include a similar powder additive stage between the hammer mill 32 and the powder burner 34. In this embodiment, one or more additive powder products may be selectively added to the powder product produced by the hammer mill 32, and then combines using a conventional powder product mixer. Alternatively, the one or more powder products may be added directly to the hammer mill 32. In this case, the powder product exiting the hammer mill 32 may or may not require further mixing before being burned in the powder burner 34. In either case, the one or more additive powder products may have BTU enhancing properties, nutrient content enhancing properties and/or one or more properties that result in achieving one or more safety goals.

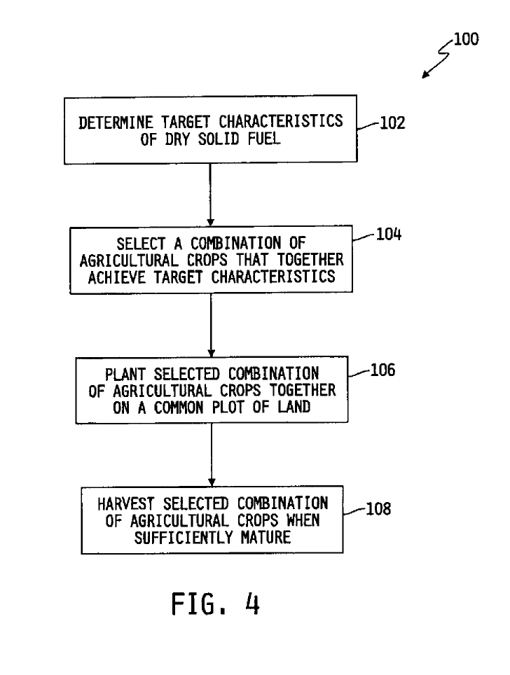

Agricultural plants are generally known to have various physical characteristics and properties. In another exemplary embodiment of this disclosure, a number of such plants having various desirable physical characteristics are grown together on a common plot of land to form a crop combination. The crop combination is harvested when sufficiently mature, and then processed to form a dry solid fuel suitable for burning to produce heat, and from which the ash resulting from the burn may be used as fertilizer. Referring now to FIG. 4, a flowchart is shown of one illustrative process 100 for growing a number of agricultural plants together on a single or common plot of land to form a crop combination that achieves one or more target characteristics of a resulting solid fuel. The process 100 begins at step 102 where one or more target characteristics of the dry solid fuel are determined or specified. Thereafter at step 104, a combination of agricultural crops is selected that together achieve the target characteristics.

Examples of target characteristics of the dry solid fuel that may be determined or specified at step 102 include, but are not limited to, a target BTU range, a target nutrient value of ash resulting from the burning of the dry solid fuel, sufficient binder or other content resulting in a product binding property that causes the dry solid fuel to produce less dust than without the binding property, particularly, although not exclusively, during and after grinding or milling of the dry solid fuel into a powered or pelletized fuel, low or negligible silicate content, low emissions of undesirable elements upon burning of the dry solid fuel, and the like. Generally, binder plants or other binder additives act to reduce dust that may be generated during manufacturing, storage and/or handling, and may have one or more additional properties as well. Examples of such one or more additional properties may include, but are not limited to, enhanced BTU value, enhanced nutrient value and providing for fertilization of future crops on the common plot land. One or more specific plants that are common, or that may otherwise be grown, in the geographical area of interest may be selected at step 104, based on the target characteristics, to have a BTU value or range of values that result in the total crop combination having a BTU value that is within a specified range of BTU values, to have a nutrient value or range of nutrient values that result in the total crop combination having a nutrient value that is within a range of specified nutrient values so ash from the burning thereof may be used as a fertilizer, that have sufficient binder or other content to act as a binder for the dry solid fuel, that will result in the total crop combination having low or negligible silicate content (e.g., sunflowers, soybeans and the like), that will result in the total crop combination having acceptable release of emissions upon burning thereof, and the like. One or more specific plants that are common, or that may otherwise be grown, in the geographical area of interest may also be selected at step based on other target characteristics of the crop combination. Examples include, but are not limited to, one or more specific plants that naturally ward off weeds, insect pests and/or animal pests (e.g., marigolds), one or more specific plants that provide fibrous bulk for burning and for producing nutritional ash or one or more specific plants that result in the crop combination having sufficient fibrous bulk for burning and for producing nutritional ash (e.g., alfalfa, legumes and the like), one or more plants that provide natural fertilizer for remaining plants in the crop combination being grown on the common plot of land, and one or more plants that provide a natural canopy to protect the remaining plants while growing. Generally, the types and numbers of specific plants grown on the common plot of land to form the crop combination will be selected based on factors relating to the locality of the common plot of land including, for example, but not limited to, terrain, climate and soil content. Such plants may be selected in many regions that allow for at least two plantings and harvesting per year. The combination of agricultural plants may alternatively or additionally be selected to achieve one or more of the properties described hereinabove with respect to FIGS. 1-3.

From step 104, the process 100 advances to step 106 where the selected combination of agricultural crops are planted together on a common plot of land. Thereafter at step 108, the selected combination of agricultural crops are harvested in a conventional manner, e.g., by cutting and chopping, when the combination is sufficiently mature.

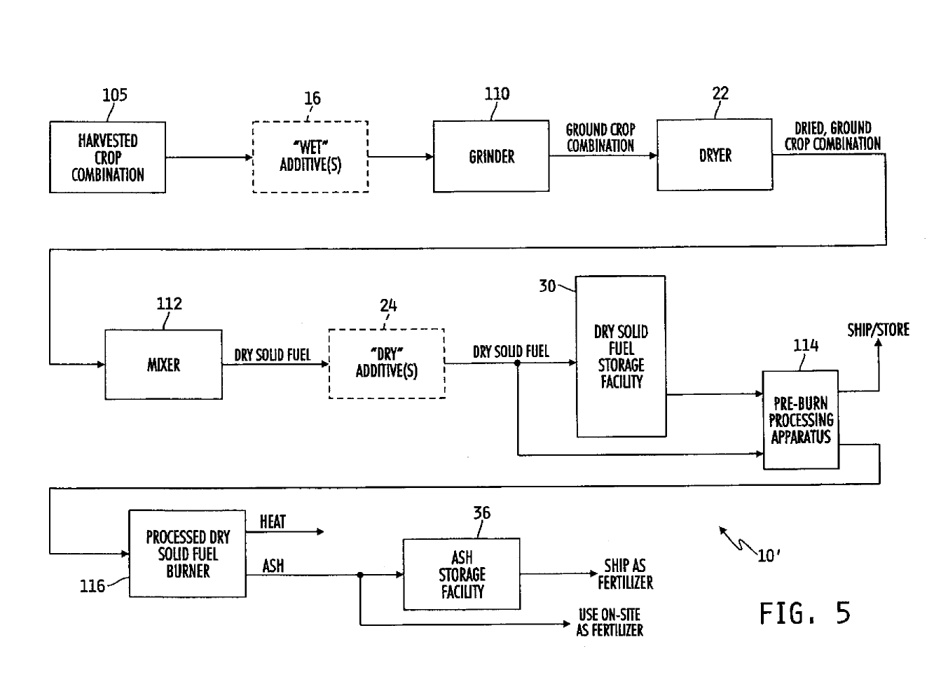

Referring now to FIG. 5, a block diagram of a system 10′ for processing the crop combination resulting from the process of FIG. 4 into a burnable solid fuel. The system 10′ has some components in common with system 10, and like numbers are therefore used to identify like components. In the illustrated embodiment, some of the stages of the system 10′ are optional, and therefore may or may not be included in particular embodiments of the system 10. Such optional stages will be identified in the following description.

In the system 10′ illustrated in FIG. 5, the harvested crop combination 105, resulting from, for example, step 108 of the process 100 of FIG. 4, is provided to a grinder 110 configured to grind the harvested crop combination 105 into a ground crop combination. Optionally, as shown in phantom, a “wet” additive stage 16, identical to the mixing stage 16 of the system 10 illustrated and described hereinabove, may be interposed between the harvested crop combination 105 and the grinder 110 to introduce one or more wet or dry additives to the harvested crop combination 105 as will be described in greater detail hereinafter. In any case, the grinder 110 may be a conventional grinder operable to reduce the harvested crop combination 105 to small pieces. Following the grinder 110, the system 10′ includes a conventional dryer 22 that may be identical to the dryer 22 illustrated and described hereinabove with respect to the system 10. The dryer 22 is configured to dry the ground crop combination to produce a dried, ground crop combination. Following the dryer 22, a conventional mixer 112 is provided to receive the dried, ground crop combination. The mixer 112 is configured to mix the dried, ground crop combination, resulting in a dry solid fuel. It will be understood that the mixer 112 may not be required in embodiments of the system 10′ wherein the grinder 110 and/or dryer 22 sufficiently mixes the crop combination. In such embodiments, the mixer 112 is therefore optional.

The dry solid fuel exiting the mixer 112 (or dryer 22 in some embodiments) is then stored in an optional dry solid fuel storage facility 30 and/or is provided to a pre-burn processing apparatus 114. Optionally, as shown in phantom, a “dry” additive stage 24, identical to the mixing stage 24 of the system 10 illustrated and described hereinabove, may be interposed between the mixer 112 (or dryer 22 in some embodiments) and the storage facility 30 and/or pre-burn processing apparatus 114. The “dry” additive stage 24 may be used to introduce one or more wet or dry additives to the dry solid fuel exiting the mixer 112 (or dryer 22 in some embodiments) as will be described in greater detail hereinafter. In any case, the optional dried product storage facility 30 may be used to store the dry solid fuel for subsequent shipment to another location or for subsequent supply to the pre-burn processing apparatus 114 as illustrated in FIG. 5.

In one embodiment, the pre-burn processing apparatus is provided in the form of a conventional hammer mill, which may be identical to the hammer mill 32 illustrated in FIG. 1 and described hereinabove. In this embodiment, the hammer mill is configured to reduce the dry solid fuel to a powdered fuel. The powdered fuel may then be shipped for use or storage at another location, stored on-site, or may be instead be supplied to an on-site processed dry solid fuel burner 116 which, in this embodiment, is provided in the form of a conventional on-site powder burner of the type illustrated and described hereinabove. The powder burner 116 in this embodiment is configured to burn the dry powdered fuel to produce heat having BTU value that is within the range of BTU values defined by the agricultural crop combination resulting from step 108 of the process 100 of FIG. 4. The ash resulting from this burn will have nutrient content in an amount that is also defined by the agricultural crop combination resulting from step 109 of the process 100 of FIG. 4, and which has value as fertilizer. The system 10′ may therefore optionally have an ash storage facility 36 that is sized and configured to store the ash produced by the burn for later use on-site, or for shipment to another location for use, as fertilizer. Alternatively, the ash may be used directly and immediately on-site as a fertilizer product.

In an alternate embodiment, the pre-burn processing apparatus is provided in the form of a conventional pellet making apparatus or pelletizer. In this embodiment, the pelletizer is configured to produce fuel pellets from the dry solid fuel in a conventional manner. The fuel pellets may then be shipped for use or storage at another location, stored on-site, or may be instead be supplied to an on-site processed dry solid fuel burner 116 which, in this embodiment, is provided in the form of a conventional solid pellet burner. It will be understood that the hammer mill 32 and powder burner 34 in the system 10 of FIG. 1 may likewise be replaced by such a pelletizer and pellet burner. In any case, the pellet burner 116 in this embodiment is configured to burn the fuel pellets to produce heat having BTU value that is within the range of BTU values defined by the agricultural crop combination resulting from step 108 of the process 100 of FIG. 4. As with the previous embodiment, the ash resulting from this burn will have nutrient content in an amount that is also defined by the agricultural crop combination resulting from step 109 of the process 100 of FIG. 4, and which has value as fertilizer. The ash may be stored in the ash storage facility 36 for later use on-site, or for shipment to another location for use, as fertilizer. Alternatively, the ash may be used directly and immediately on-site as a fertilizer product.

The present disclosure contemplates various configurations of the system 10′ with regard to its components. In one embodiment, for example, the system 10 may omit the “wet” additive stage 16 and the “dry” additive stage 24. This embodiment may be appropriate, for example, when the one or more target properties or characteristics of the dry solid fuel specified at step 102 of the process 100 of FIG. 4 can be satisfied by selection and planting of suitable agricultural plants at the location of the common plot of land. In this embodiment, the dry solid fuel is produced with the system 10′ by grinding the agricultural crop combination resulting from the process 100 of FIG. 4 into a ground crop combination with the grinder 16, drying the ground crop combination in the dryer 22 to produce a dried, ground crop combination, and mixing the dried, ground crop combination to produce the dry solid fuel. As described hereinabove, the mixer 112 may be omitted in some embodiments wherein the grinder 110 and/or drier 22 provide for adequate mixing of the dry solid fuel.

In another embodiment of the system 10′, the “wet” additive stage 16 may be included, and the “dry” additive stage 24 may be omitted. In this embodiment, the “wet” additive stage 16 may be implemented to mix the harvested crop combination 105 with at least one wet or dry additive to form a resulting product that has at least one physical characteristic that is different than that of the harvested crop combination 105. This embodiment may be appropriate, for example, when one or more of the target characteristics of the dry solid fuel specified at step 102 of the process 100 of FIG. 4 cannot be satisfied, or can be satisfied only at great expense or hardship, by selection and planting of suitable agricultural plants at the location of the common plot of land. In this embodiment, the “wet” additive stage 16 may thus be used to provide one or more wet and/or dry additives to the harvested crop combination that provides or augments one or more of the target properties or characteristics of the dry solid fuel specified at step 102 of the process 100 of FIG. 4, where examples of such target properties or characteristics have been described herein. Generally, the one or more wet or dry additives added by additive stage 16 will be organic and/or biological waste that will not, or will only minimally, adversely affect the various other target characteristics of the dry solid fuel specified at step 102 of the process of FIG. 1. One or more “wet” additives may thus be added by the stage 16 to cause the BTU value of the resultant product to increase, to cause the nutrient value of the resultant product to increase, or the like.

As one specific example, it may be that in a particular geographical region it is difficult and/or prohibitively expensive to grow plants having sufficient oil content to act as a binder for the dry solid fuel, and/or it may be that other organic and/or biological waste is inexpensively available in sufficient quantities that can satisfy the target binder characteristic. Examples of such organic and/or biological waste that may satisfy the binder characteristic may include, but are not limited to, spent fowl or other wildlife, waste produced by various food industries, and the like. Other examples will occur to those skilled in the art, and any such other examples are contemplated by this disclosure. In any case, the one or more “wet” additives in this embodiment are added to the harvested crop combination 105 at the “wet” additive stage 16, and the combination is then ground in the grinder 110, dried in the dryer 22 and mixed by the mixer 112 to produce the dry solid fuel.

In another embodiment of the system 10′, the “dry” additive stage 24 may be included, and the “wet” additive stage 16 may be omitted. In this embodiment, the “dry” additive stage 24 may be implemented to mix the dried, ground crop combination exiting the dryer 22 with at least one dry additive to form a resulting product that has at least one physical characteristic that is different than that of the dried, ground crop combination. This embodiment may be appropriate, for example, when one or more of the target characteristics of the dry solid fuel specified at step 102 of the process 100 of FIG. 4 cannot be satisfied, or can be satisfied only at great expense or hardship, by selection and planting of suitable agricultural plants at the location of the common plot of land. In this embodiment, the “dry” additive stage 24 may thus be used to provide one or more dry additives to the dried, ground crop combination that provides or augments one or more of the target characteristics of the dry solid fuel specified at step 102 of the process 100 of FIG. 4, where examples of such target characteristics were described hereinabove. Generally, the one or more wet or dry additives added by additive stage 16 will be organic and/or biological waste that will not, or will only minimally, adversely affect the various other target characteristics of the dry solid fuel specified at step 102 of the process of FIG. 1. One or more “dry” additives may thus be added by the stage 24 to cause the BTU value of the resultant product to increase, to cause the nutrient value of the resultant product to increase, or the like.

Again using the previous specific example, it may be that in a particular geographical region it is difficult and/or prohibitively expensive to grow plants having sufficient oil content to act as a binder for the dry solid fuel, and/or it may be that other organic and/or biological waste is inexpensively available in sufficient quantities that can satisfy the target binder characteristic. Examples of such organic and/or biological waste that may satisfy the binder characteristic may include, but are not limited to, wax, dry food waste that has sticky or adhesive properties, wet food or other organic waste that has sticky or adhesive properties, and the like. Other examples will occur to those skilled in the art, and any such other examples are contemplated by this disclosure. In any case, the one or more “dry” additives in this embodiment are added to the dried, ground crop combination at the “dry” additive stage 24. In this embodiment, the mixer of the stage 24 or the mixer 112 may be omitted.

In another embodiment of the system 10′, the “wet” additive stage 16 and the “dry” additive stage 24 may be included to provide or augment one or more of the target characteristics of the dry solid fuel specified at step 102 of the process 100 of FIG. 4.

It will be understood that one or more of the structures and one or more of the aspects of the processes described separately hereinabove with respect to FIGS. 1-3 and with respect to FIGS. 4-5, may be combined to achieve one or more goals and/or properties of the resulting fuel combination described herein. For example, the base material for a burnable solid fuel may be either, or both, of biomaterial waste and one or more agricultural plants. One or various combinations of biomaterial, wet and/or dry additives may then be added to the base material to achieve one or more desired properties of the resulting burnable solid fuel that is/are different than that of the base material. Examples of the one or more desirable properties of the resulting burnable solid fuel include, but are not limited to, a desired BTU value or range of values, a desired nutrient content, reduced dust production from handling of the resulting burnable solid fuel, controlled emission of one or more elements resulting from burning of the burnable solid fuel and lubricity of one or more solid fuel processing structures. The resulting burnable fuel may be processed to form a powdered fuel suitable for burning in a conventional powdered fuel burner or to form fuel pellets suitable for burning in a conventional pellet fuel burner.

1-29. (canceled)

30. A method of producing a dry solid fuel, comprising:
growing a combination of a number of agricultural plants together on a common plot of land,
including in the combination of a number of agricultural plants one or more additional plants which will result in a total crop combination, including the combination of a number of agricultural plants and the one or more additional plants, having low or negligible silicate content,
grinding the total crop combination into a ground crop combination,
drying the ground crop combination, and
mixing the ground crop combination to produce the dry solid fuel.

31. The method of claim 30 wherein the one or more additional plants comprise at least one of sunflowers and soybeans.

32. The method of claim 30 wherein growing the combination of a number of agricultural plants comprises including in the combination one or more plants that cause the combination of a number of agricultural plants to have a BTU value that is within a range of BTU values.

33. The method of claim 30 wherein growing the combination of a number of agricultural plants comprises including in the combination one or more plants that cause the combination of a number of agricultural plants to have a nutrient value that is within a range of nutrient values.

34. The method of claim 30 wherein growing the combination of a number of agricultural plants comprises including in the combination one or more plants that provide fibrous bulk for burning and for producing nutritional ash.

35. The method of claim 34 wherein the one or more plants that provide fibrous bulk for burning and for producing nutritional ash comprise at least one of alfalfa and legumes.

36. The method of claim 30 further comprising including in the combination of a number of agricultural plants one or more specific plants that naturally ward off at least one of insect pests and animal pests.

37. The method of claim 36 wherein the one or more specific plants comprises marigolds.

38. The method of claim 30 wherein growing the combination of a number of agricultural plants comprises including in the combination one or more plants that act as a binder for the dry solid fuel when ground or milled.

39. The method of claim 30 wherein growing the combination of a number of agricultural plants comprises including in the combination one or more plants that provide natural fertilizer for remaining ones of the number of agricultural plants being grown on the common plot of land.

40. The method of claim 30 further comprising:
burning the dry, solid fuel, and
using ash resulting from burning the dry solid fuel as fertilizer.
